(19) United States
(12) Patent Application Publication
(10) Pub. No.: US 2025/0023427 A1
(43) Pub. Date: Jan. 16, 2025

(54) ELECTRIC VEHICLE

(71) Applicant: TOYOTA JIDOSHA KABUSHIKI KAISHA, Toyota-shi Aichi-ken (JP)

(72) Inventor: Hyuksoo KWON, Anjo-shi Aichi-ken (JP)

(73) Assignee: TOYOTA JIDOSHA KABUSHIKI KAISHA, Toyota-shi Aichi-ken (JP)

(21) Appl. No.: 18/763,350

(22) Filed: Jul. 3, 2024

(30) Foreign Application Priority Data
Jul. 10, 2023 (JP) 2023-113334

(51) Int. Cl. H02K 9/193; B60K 1/02; B60L 15/00; B60L 15/02; F16H 57/02; H02K 7/00; H02K 7/116

(52) U.S. Cl. CPC H02K 9/193; B60K 1/02; B60L 15/007; B60L 15/02; F16H 57/02; H02K 7/006; H02K 7/116; F16H 2057/02034; F16H 2057/02043

(57) ABSTRACT

An electric vehicle includes: (a) an electric motor; (b) a power transmission device to which the electric motor is connected in a power transmittable manner; (c) a driving battery; (d) an electric-power control apparatus configured to control an electric power transmitted and received between the battery and the electric motor; (e) a mechanical-electrical integrated unit constituted by the electric-power control apparatus and a drive apparatus that includes the electric motor and the power transmission device; (f) a casing that houses the mechanical-electrical integrated unit; (g) an oil pump configured to discharge an oil; and (h) a cooling oil passage configured to supply the oil to the electric motor for cooling the electric motor. The electric-power control apparatus is disposed adjacent to and above the electric motor in a vertical direction of the electric vehicle. The cooling oil passage is disposed between the electric motor and the electric-power control apparatus.

### CROSS-REFERENCE TO RELATED APPLICATIONS

This application claims priority from Japanese Patent Application No. 2023-113334 filed on Jul. 10, 2023, the disclosure of which is herein incorporated by reference in its entirety.

### TECHNICAL FIELD

The present disclosure relates to an electric vehicle including a cooling oil passage configured to supply an oil to an electric motor for cooling the electric motor.

### BACKGROUND

There is well known an electric vehicle including (a) an electric motor, (b) a power transmission device to which the electric motor is connected in a power transmittable manner, (c) a driving battery, (d) an electric-power control apparatus configured to control an electric power transmitted and received between the battery and the electric motor, (c) a mechanical-electrical integrated unit constituted by the electric-power control apparatus and a drive apparatus that includes the electric motor and the power transmission device, and (f) a casing that houses the mechanical-electrical integrated unit. For example, JP 2022-161294 A discloses a mechanical-electrical integrated device. In this Japanese Patent Application Publication, the casing is provided with a partition wall, such that a part of the electric-power control apparatus is located on an upper surface of the partition wall while another part of the electric-power control apparatus is located on a lower surface of the partition wall. The partition wall defines therein a cooling passage through which a liquid refrigerant is to flow.

### SUMMARY

By the way, in the mechanical-electrical integrated unit, the electric-power control apparatus is disposed adjacent to and above the electric motor in a vertical direction of the electric vehicle, so that a physical distance between the electric motor and the electric-power control apparatus needs to be reduced for making the mechanical-electrical integrated unit compact in size. In the mechanical-electrical integrated device disclosed in JP 2022-161294 A, for example, if the physical distance between the electric motor and the electric-power control apparatus is reduced, heat is easily received between the above-described another part of the electric-power control apparatus and the electric motor through atmospheric temperature and the casing, for example. It is desirable to suppress heat generation in the electric-power control apparatus. Further, it is desirable to suppress heat generation also in the electric motor, since the heat generation is likely to demagnetize the electric motor so as to reduce performance of the electric motor. There is also well-known an electric vehicle including an oil pump configured to discharge an oil and a cooling oil passage configured to supply the oil to an electric motor for cooling the electric motor. There is a room for improvement in using this cooling oil passage.

The present disclosure was made in view of the background art described above. It is therefore an object of the present disclosure to provide an electric vehicle capable of improving performance for cooling an electric motor and an electric-power control apparatus.

The object indicated above is achieved according to the following aspects of the present disclosure.

According to a first aspect of the present disclosure, there is provided an electric vehicle including: (a) an electric motor; (b) a power transmission device to which the electric motor is connected in a power transmittable manner; (c) a driving battery; (d) an electric-power control apparatus configured to control an electric power transmitted and received between the battery and the electric motor; (e) a mechanical-electrical integrated unit constituted by the electric-power control apparatus and a drive apparatus that includes the electric motor and the power transmission device; (f) a casing that houses the mechanical-electrical integrated unit; (g) an oil pump configured to discharge an oil; and (h) a cooling oil passage configured to supply the oil to the electric motor for cooling the electric motor. The electric-power control apparatus is disposed adjacent to and above the electric motor in a vertical direction of the electric vehicle. The cooling oil passage is disposed between the electric motor and the electric-power control apparatus.

According to a second aspect of the present disclosure, in the electric vehicle according to the first aspect of the present disclosure, there are further provided a plurality of power lines that electrically connect between the electric motor and the electric-power control apparatus, wherein the cooling oil passage is disposed between two of the power lines.

According to a third aspect of the present disclosure, in the electric vehicle according to the first or second aspect of the present disclosure, the two of the plurality of power lines are shorter than another of the plurality of power lines.

According to a fourth aspect of the present disclosure, in the electric vehicle according to the second aspect of the present disclosure, the electric-power control apparatus includes an inverter that has a three-phase bridge circuit of U phase, V phase and W phase, wherein the electric motor is a three-phase alternating-current synchronous motor that is to be driven by the inverter, and wherein the plurality of power lines are three power lines configured to transmit a three-phase alternating current of U phase, V phase and W phase.

According to a fifth aspect of the present disclosure, in the electric vehicle according to the fourth aspect of the present disclosure, the two of the plurality of power lines are shorter than another of the plurality of power lines.

According to a sixth aspect of the present disclosure, in the electric vehicle according to any one of the second through fifth aspects of the present disclosure, the plurality of power lines include a plurality of electric-motor-side power line portions and a plurality of electric-power-control-apparatus-side power line portions, such that the electric-motor-side power line portions are connected to the electric motor while the electric-power-control-apparatus-side power line portions are connected to the electric-power control apparatus. The electric vehicle further includes a terminal block that connects between each of the electric-motor-side power line portions and a corresponding one of the electric-power-control-apparatus-side power line portions, wherein the cooling oil passage is disposed between two of the electric-motor-side power line portions which are included in the two of the power lines.

According to a seventh aspect of the present disclosure, in the electric vehicle according to any one of the first through sixth aspects of the present disclosure, the electric motor includes a first electric motor and a second electric motor, wherein the drive apparatus is disposed in the electric vehicle, such that a rotation axis of the first electric motor, a rotation axis of the second electric motor and a rotation axis of the power transmission device are parallel to a horizontal direction that is perpendicular to a longitudinal direction of the electric vehicle, and such that the rotation axis of the second electric motor and the rotation axis of the first electric motor are arranged in this order of description from above to below in the vertical direction, wherein the electric-power control apparatus includes a lower-side portion which is located in a position overlapping with an upper-side portion of the second electric motor as seen in the longitudinal direction and which is located above the first electric motor in the vertical direction, and wherein the cooling oil passage is located between the first electric motor and the lower-side portion of the electric-power control apparatus.

According to an eighth aspect of the present disclosure, in the electric vehicle according to any one of the first through seventh aspects of the present disclosure, the cooling oil passage extends in parallel to a rotation axis of the electric motor.

In the electric vehicle according to the first aspect of the present disclosure, the cooling oil passage, which is configured to supply the oil to the electric motor for cooling the electric motor, is disposed between the electric motor and the electric-power control apparatus that is disposed adjacent to and above the electric motor in the vertical direction of the electric vehicle. Owing to this arrangement, both of the electric motor and the electric-power control apparatus are cooled by the oil injected from the cooling oil passage, whereby heat generation in the electric motor and the electric-power control apparatus can be suppressed. It is therefore possible to improve performance for cooling the electric motor and the electric-power control apparatus.

In the electric vehicle according to the second aspect of the present disclosure, the cooling oil passage is disposed between the two of the power lines that electrically connect between the electric motor and the electric-power control apparatus. With reduction of a physical distance between the electric motor and the electric-power control apparatus, the power lines are shortened whereby heat dissipation of the power lines is reduced. The reduction of the heat dissipation of the power lines causes heat to be easily received between the electric motor and the electric-power control apparatus. However, in the second aspect of the present disclosure, the power lines are cooled by the oil injected from the cooling oil passage, so that it is possible to suppress heat from being received between the electric motor and the electric-power control apparatus.

In the electric vehicle according to the third aspect of the present disclosure, the above-described two of the plurality of power lines are shorter than another of the plurality of power lines. Owing to this arrangement, the two power lines having shorter lengths and poorer heat dissipation are cooled, so that it is possible to efficiently suppress heat from being received between the electric motor and the electric-power control apparatus.

In the electric vehicle according to the fourth aspect of the present disclosure, the plurality of power lines are three power lines configured to transmit the three-phase alternating current of U phase, V phase and W phase, so that the cooling oil passage is disposed between two of the three power lines configured to transmit the three-phase alternating current. Owing to this arrangement, the power lines are cooled by the oil injected from the cooling oil passage, so that it is possible to suppress heat from being received between the electric motor and the electric-power control apparatus.

In the electric vehicle according to the fifth aspect of the present disclosure, the above-described two of the plurality of power lines are shorter than another of the plurality of power lines. Owing to this arrangement, the two power lines having shorter lengths and poorer heat dissipation are cooled, so that it is possible to efficiently suppress heat from being received between the electric motor and the electric-power control apparatus.

In the electric vehicle according to the sixth aspect of the present disclosure, the cooling oil passage is disposed between the two of the electric-motor-side power line portions that are located between the electric motor and the terminal block. Owing to this arrangement, the power lines are cooled by the oil injected from the cooling oil passage, so that it is possible to suppress heat from being received between the electric motor and the electric-power control apparatus.

In the electric vehicle according to the seventh aspect of the present disclosure, the drive apparatus is disposed in the electric vehicle, such that the rotation axis of the second electric motor and the rotation axis of the first electric motor are arranged in this order of description from above to below in the vertical direction. Further, the electric-power control apparatus includes the lower-side portion which is located in the position overlapping with the upper-side portion of the second electric motor as seen in the longitudinal direction and which is located above the first electric motor in the vertical direction. Still further, the cooling oil passage is located between the first electric motor and the lower-side portion of the electric-power control apparatus. Owing to these arrangements, the first electric motor and the lower-side portion of the electric-power control apparatus are both cooled by the oil injected from the cooling oil passage whereby heat generation can be suppressed in the electric motor and the electric-power control apparatus.

In the electric vehicle according to the eighth aspect of the present disclosure, the cooling oil passage extends in parallel to the rotation axis of the electric motor. Owing to this arrangement, the cooling oil can be caused to flow from above to down in the vertical direction, over an entirety of the electric motor in the direction of the rotation axis, whereby the entirety of the electric motor can be efficiently cooled.

### BRIEF DESCRIPTION OF THE DRAWINGS

FIG. 1 is a view showing, by way of example, a construction of an electric vehicle to which the present disclosure is applied, wherein the electric vehicle is constructed according to an embodiment of the present disclosure;

FIG. 2 is a view showing, by way of example, an electrical configuration related to control of an electric motor, for example;

FIG. 3 is a view showing, by way of example, a construction of a mechanical-electrical integrated unit;

FIG. 4 is a view showing, by way of example, a cooling system using an oil;

FIG. 5 is a view showing, by way of example, a construction of a cover of a casing in the cooling system using the oil;

FIG. 6 is a view showing, by way of example, the cooling system in which a cooling pipe is disposed between bus bars;

FIG. 7 is a view showing, by way of example, a range in which the cooling pipe is disposed; and

FIG. 8 is a view showing, by way of example, a construction of an electric vehicle to which the present disclosure is applied, wherein the electric vehicle is constructed according to a modification of the embodiment of the present disclosure.

### DETAILED DESCRIPTION OF EMBODIMENTS

Hereinafter, an embodiment of the present disclosure will be described in detail with reference to the accompanying drawings.

### Embodiment

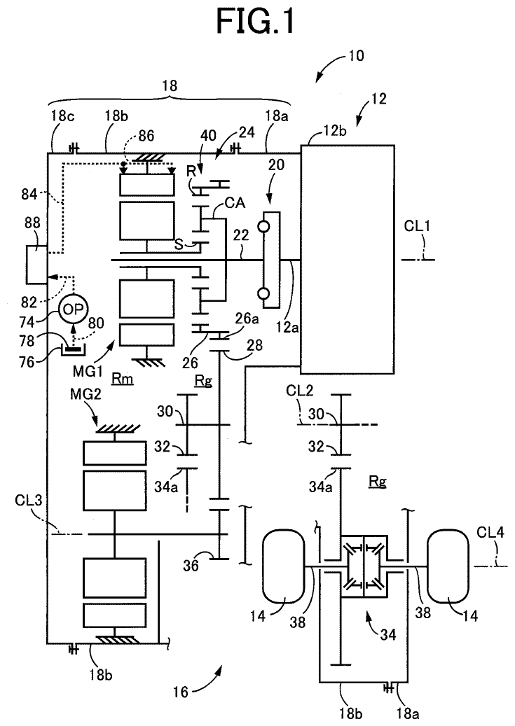

FIG. 1 is a view schematically showing a construction of an electric vehicle 10 to which the present disclosure is applied, wherein the electric vehicle 10 is constructed according to the present embodiment of the present disclosure. As shown in FIG. 1, the electric vehicle 10 is a hybrid electric vehicle including an engine 12 functioning as a power source and a second electric motor MG2 that is an electric motor functioning as a power source. The electric vehicle 10 (hereinafter simply referred to as “vehicle 10”) includes drive wheels 14, a power transmission device 16 and a first electric motor MG1.

The engine 12 is a known internal combustion engine. The drive wheels 14 are left and right wheels with respect to forward and backward directions of the vehicle 10. The power transmission device 16 is provided in a power transmission path between the engine 12 and the drive wheels 14 and a power transmission path between the second electric motor MG2 and the drive wheels 14.

The first electric motor MG1 and the second electric motor MG2 are known rotary electric machines, so-called motor generators, each having a function as a motor that generates a mechanical power from an electric power and a function as a power generator that generates an electric power from a mechanical power. The first electric motor MG1 and the second electric motor MG2 are provided in a non-rotatable casing 18 which is a non-rotatable member attached to a body of the vehicle 10.

The power transmission device 16 includes a damper 20, an input shaft 22, a transmission portion 24, a composite gear 26, a driven gear 28, a driven shaft 30, a final gear 32, a differential gear device 34 and a reduction gear 36 that are housed in the casing 18. The power transmission device 16 includes a pair of drive shafts 38 connected to the differential gear device 34.

The damper 20 is connected to a crankshaft 12a of the engine 12. The input shaft 22 functions as an input rotary member of the transmission portion 24. The input shaft 22 is connected to the damper 20, and is connected to the crankshaft 12a via the damper 20 and the like. The transmission portion 24 is connected to the input shaft 22. The composite gear 26 is a rotary body on an output side of the transmission portion 24. The composite gear 26 has a drive gear 26a formed on a part of an outer peripheral surface thereof. The drive gear 26a is an output-side rotary member of the transmission portion 24. The driven gear 28 meshes with the drive gear 26a. The driven gear 28 and the final gear 32 are fixed onto the driven shaft 30 so as not to be relatively rotatable. The final gear 32 has a smaller diameter than the driven gear 28 and meshes with a differential ring gear 34a. The reduction gear 36 has a smaller diameter than the driven gear 28 and meshes with the driven gear 28. A rotor shaft of the second electric motor MG2 is connected to the reduction gear 36, so that the second electric motor MG2 is connected to the reduction gear 36 in a power transmittable manner.

The power transmission device 16 constructed as described above is suitably used for a vehicle of a front engine front drive (FF) type or a rear engine rear drive (RR) type. The power transmission device 16 transmits a power outputted from the engine 12 to the driven gear 28 via the transmission portion 24. The power transmission device 16 transmits a power outputted from the second electric motor MG2 to the driven gear 28 via the reduction gear 36. The power transmission device 16 transmits the power transmitted to the driven gear 28 to the drive wheels 14 sequentially via the driven shaft 30, the final gear 32, the differential gear device 34, the drive shafts 38 and the like. The driven gear 28, the driven shaft 30, and the final gear 32 constitute a transmission mechanism that transmits the power from the second electric motor MG2 to the drive gear 26a. The differential gear device 34 distributes the power from the engine 12 and the second electric motor MG2 to the drive wheels 14. The drive shafts 38 transmits the power from the differential gear device 34 to the drive wheels 14. The 30) second electric motor MG2 is connected to the drive wheels 14 in a power transmittable manner.

The transmission portion 24 includes the first electric motor MG1 and a differential mechanism 40. The differential mechanism 40 is a known single-pinion planetary gear device including a sun gear S, a carrier CA and a ring gear R. The sun gear S is connected to the rotor shaft of the first electric motor MG1. That is, the first electric motor MG1 as an electric motor is connected to the differential mechanism 40 as a part of the power transmission device 16 in a power transmittable manner. The carrier CA is connected to the input shaft 22. That is, the differential mechanism 40 is connected to the engine 12 via the input shaft 22 and the like in a power transmittable manner. The ring gear R is formed on a part of an inner peripheral surface of the composite gear 26, and is integrally connected to the drive gear 26a. That is, the differential mechanism 40 is connected to the drive wheels 14 in a power transmittable manner.

The differential mechanism 40 functions as a differential mechanism which is connected to the engine 12 in a power transmittable manner and which generates a differential action. The first electric motor MG1 is a differential-purpose electric motor that is connected to the differential mechanism 40 in a power transmittable manner. The differential mechanism 40 is a power split mechanism that mechanically splits the power of the engine 12 to the first electric motor MG1 and the drive gear 26a. The transmission portion 24 is a known electric transmission mechanism in which a differential state of the differential mechanism 40 is controlled with an operation state of the first electric motor MG1 being controlled.

The power transmission device 16 has a first axis CL1, a second axis CL2, a third axis CL3 and a fourth axis CL4. These four axes CL1, CL2, CL3, CL4 are parallel to one another. The first axis CL1 is an axis of each of the input shaft 22 and the rotor shaft of the first electric motor MG1. That is, the first axis CL1 is a rotation axis of the first electric motor MG1. The transmission portion 24 and the first electric motor MG1 are disposed around the first axis CL1. The second axis CL2 is an axis of the driven shaft 30. The driven gear 28 and the final gear 32 are disposed around the second axis CL2. That is, the second axis CL2 is a rotation axis of each of the driven gear 28, the driven shaft 30 and the final gear 32. The third axis CL3 is an axis of the 25 MG2 rotor shaft RSmg2. That is, the third axis CL3 is a rotation axis of the second electric motor MG2. The second electric motor MG2 and the reduction gear 36 are disposed around the third axis CL3. The fourth axis CL4 is an axis of each of the drive shafts 38. That is, the fourth axis CL4 is a rotation axis of each of the drive shafts 38 and the differential gear device 34. The differential gear device 34 is disposed around the fourth axis CL4. The second axis CL2 and the fourth axis CL4 are rotation axes of the power transmission device 16.

The casing 18 includes a housing 18a, a main body 18b and a cover 18c. The housing 18a includes an opening portion on a side of the engine 12. The engine 12 includes an engine block 12b that is connected to the opening portion of the housing 18a. The housing 18a includes another opening portion that is remote from the engine 12. The housing 18a and the main body 18b are integrally connected by fasteners such as bolts such that the another opening portion of the housing 18a and an opening portion of the main body 18b, which are opposed to each other, are aligned with each other. The main body 18b and the cover 18c are integrally connected by fasteners such as bolts such that the cover 18c closes another opening portion of the main body 18b that is remote from the engine 12. The main body 18b is a casing including a partition wall (not shown) that separates a gear room Rg and a motor room Rm from each other, wherein the gear room Rg houses the transmission portion 24, the driven gear 28, the deferential gear device 34 and the like, while the motor room Rm houses the first electric motor MG1 and the second electric motor MG2. The main body 18b cooperates with the housing 18a to form the gear room Rg. The main body 18b cooperates with the cover 18c to form the motor room Rm. Thus, the casing 18 houses the first electric motor MG1, the second electric motor MG2 and the power transmission device 16 except the drive shafts 38 and the like.

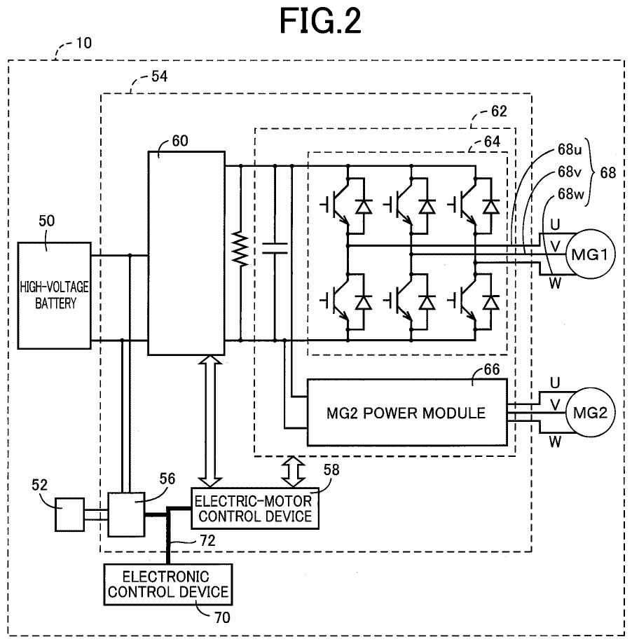

FIG. 2 is a view showing, by way of example, an electrical configuration related to control of the first and second electric motors MG1, MG2, for example. As shown in FIG. 2, the vehicle 10 further includes a high-voltage battery 50, an auxiliary battery 52 and an electric-power control unit 54.

The high-voltage battery 50 is a chargeable and dischargeable DC power supply, and is a secondary battery such as a nickel-hydrogen secondary battery or a lithium ion battery. The high-voltage battery 50 is connected to the electric-power control unit 54. The stored electric power is supplied from the high-voltage battery 50 to, for example, the second electric motor MG2 via the electric-power control unit 54. The high-voltage battery 50 is supplied with the electric power generated by the first electric motor MG1 and the electric power regenerated by the second electric motor MG2 via the electric-power control unit 54. The high-voltage battery 50 is a driving battery.

The electric-power control unit 54 includes a DC-DC converter 56, an electric-motor control device 58, a boost converter 60 and an inverter 62. The electric-power control unit 54 is an electric-power control apparatus that controls the electric power transmitted and received between the high-voltage battery 50 and each of the first electric motor MG1 and the second electric motor MG2.

The DC-DC converter 56 is connected to the high-voltage battery 50. The DC-DC converter 56 functions as a charging device that reduces a voltage of the high-voltage battery 50 to a voltage equivalent to a voltage of the auxiliary battery 52, and charges the auxiliary battery 52. The auxiliary battery 52 supplies the electric power for operating auxiliary devices, the electric-motor control device 58, an electronic control device 70 and the like, which are provided in the vehicle 10.

The boost converter 60 includes a reactor and a switching element (not shown). The boost converter 60 is a step-up/down circuit having a function of boosting the voltage of the high-voltage battery 50 and supplying the boosted voltage to the inverter 62, and a function of reducing the voltage converted into a direct current by the inverter 62 and supplying the reduced voltage to the high-voltage battery 50.

The inverter 62 includes an MG1 power module 64 and an MG2 power module 66. The MG1 power module 64 is provided with a plurality of transistors 10) configured to convert direct current to three-phase alternating current by being turned ON and OFF as switching elements, and constitutes a three-phase bridge circuit of U phase, V phase and W phase. The vehicle 10 further includes bus bars 68 that electrically connect between the first electric motor MG1 and the MG1 power module 64 (i.e., the inverter 62). The bus bars 68 are power lines that electrically connect between the first electric motor MG1 and the electric-power control unit 54, and include a plurality of bus bars 68u, 68v, 68w. The plurality of bus bars 68u, 68v, 68w are three power lines through which the three-phase alternating current of U phase, V phase and W phase is to flow. The MG2 power module 66 has substantially the same construction as the MG1 power module 64, so that description of the MG2 power module 66 is not provided. Each of the first and second electric motors MG1, MG2 is a three-phase alternating-current synchronous electric motor that is to be driven by the inverter 62.

The inverter 62 converts the direct current from the boost converter 60 into the alternating current for driving the first electric motor MG1 and the second electric motor MG2. The inverter 62 converts the alternating current generated by the first electric motor MG1 using the power of the engine 12 and the alternating current generated by the second electric motor MG2 using the regenerative braking, into the direct current. The inverter 62 supplies the alternating current generated by the first electric motor MG1, as the driving power of the second electric motor MG2, in accordance with a running state of the vehicle 10.

The vehicle 10 further includes the electronic control device 70 and communication lines 72. The electronic control device 70 transmits and receives signals to and from the DC-DC converter 56 and the electric-motor control device 58 through the communication lines 72. The electronic control device 70 executes various controls in the vehicle 10, based on the signals supplied from sensors (not shown). The communication lines 72 are a known CAN (Controller Area Network) communication lines, for example.

The electric-motor control device 58 controls the boost converter 60 and the inverter 62 based on commands from the electronic control device 70, so as to control the first electric motor MG1 and the second electric motor MG2. For example, the electric-motor control device 58 converts the direct current supplied from the high-voltage battery 50, into the alternating current used for each of the first electric motor MG1 and the second electric motor MG2. The electric-motor control device 58 drives the first electric motor MG1 to secure the amount of power generation required for supplying the power to the second electric motor MG2 and charging the high-voltage battery 50. The electric-motor control device 58 drives the second electric motor MG2 based on a power demand value corresponding to the torque demanded by a driver of the vehicle 10. The electric-motor control device 58 causes the second electric motor MG2 to function as the power generator in accordance with the required amount of regenerative braking.

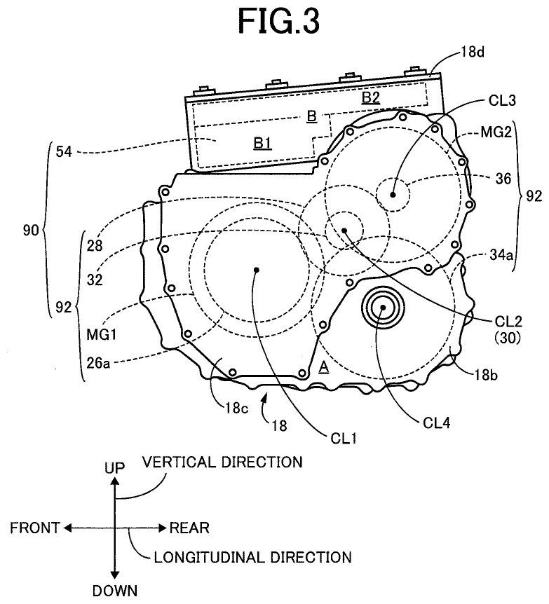

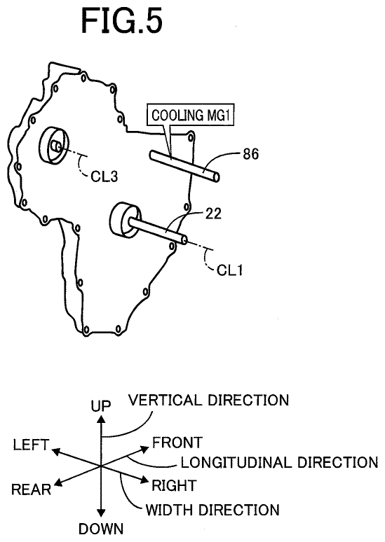

FIG. 3 is a view schematically showing, by way of example, a construction of a drive unit 90. FIG. 3 is a side view of the vehicle 10 as viewed from a left side of the vehicle 10. As shown in FIG. 3, a transaxle 92 and the electric-power control unit 54 constitute the drive unit 90, and are housed in the same casing 18. The drive unit 90 is a mechanical-electrical integrated unit, i.e., a unit in which the transaxle 92 and the electric-power control unit 54 are integrated. The transaxle 92 is a drive apparatus including the power transmission device 16 (26a, 28, 32, 34a, 36, etc.), the first electric motor MG1 and the second electric motor MG2. It is noted that “VERTICAL DIRECTION”, “LONGITUDINAL DIRECTION” and “WIDTH DIRECTION” (see FIG. 5) in the drawings indicate directions in the vehicle 10. The “WIDTH DIRECTION” is parallel to an axial direction corresponding to each of the first axis CL1, the second axis CL2, the third axis CL3 and the fourth axis CL4.

The casing 18 further includes a protection plate 18d in addition to the above-described housing 18a, main body 18b and cover 18c. The main body 18b includes a bottom wall and side walls that extend upward in the vertical direction from an outer peripheral edge of the bottom wall on front and rear sides in the longitudinal direction of the vehicle 10, and opens in its upper portion in the vertical direction of the vehicle 10. The protection plate 18d is a plate-shaped member that closes an opening in the upper portion of the main body 18b. The main body 18b has a partition wall (not shown) inside, such that an inner space of the main body 18b is divided into two spaces by the partition wall, wherein the two spaces are a lower space A as a lower portion of the inner space of the main body 18b in the vertical direction and an upper space B as an upper portion of the inner space of the main body 18b in the vertical direction.

When being installed in the vehicle 10, the transaxle 92 is housed in the housing 18a and the lower space A as the lower portion of the inner space of the main body 18b.

When being installed in the vehicle 10, the electric-power control unit 54 is housed in the upper space B as the upper portion of the inner space of the main body 18b. The upper space B includes a surplus space B1 and an uppermost space B2. The surplus space B1 is formed by arrangement of the first electric motor MG1 and the second electric motor MG2. The uppermost space B2 is located on an upper side of the second electric motor MG2 in the vertical direction. The surplus space B1 is shorter 10) than the uppermost space B2 in the longitudinal direction of the vehicle 10. That is, the electric-power control unit 54 is disposed adjacent to and above the first electric motor MG1 in the vertical direction of the vehicle 10.

For example, the DC-DC converter 56 and reactors (not shown) provided in the boost converter 60 are housed in the surplus space B1, by taking into account that they are relatively short-length components of the electric-power control unit 54 and are relatively easy to replace.

Referring to FIG. 3, the transaxle 92 is disposed such that the first axis CL1, the second axis CL2, the third axis CL3 and the fourth axis CL4 are parallel to a horizontal direction perpendicular to the longitudinal direction of the vehicle 10. Further, the first axis CL1, the second axis CL2, the third axis CL3 and the fourth axis CL4 are located relative to one another, such that the second electric motor MG2, the driven shaft 30, the first electric motor MG1 and the differential gear device 34 are arranged in this order of description from above to below in the vertical direction, and such that the first electric motor MG1, the driven shaft 30, the differential gear device 34 and the second electric motor MG2 are arranged in this order of description from 25 front to rear in the longitudinal direction. Focusing on the first electric motor MG1 and the second electric motor MG2, the transaxle 92 is disposed such that the third axis CL3 and the first axis CL1 are arranged in this order of description from above to below in the vertical direction. Thus, a vertical size of the transaxle 92 is reduced while distances among the first axis CL1, the second axis CL2, the third axis CL3 and the fourth axis CL4 are appropriately ensured. Therefore, the surplus space B1 is created by the arrangement of the first electric motor MG2 and the second electric motor B1, and the uppermost space B2 is created above the second electric motor MG2 in the vertical direction. The electric-power control unit 54 is disposed in the upper space B (B1+B2).

When being installed in the vehicle 10, the electric-power control unit 54 is disposed vertically above the transaxle 92. In addition, the electric-power control unit 54 is disposed in a position in which a lower-side portion of the electric-power control unit 54 overlaps with the transaxle 92, particularly, an upper-side portion of the second electric motor MG2, in the horizontal direction, particularly, in the longitudinal direction. In other words, when the electric-power control unit 54 is installed in the vehicle 10, the lower-side portion of the electric-power control unit 54 is disposed vertically above the first electric motor MG1. The lower-side portion of the electric-power control unit 54 is constituted by components (such as the DC-DC converter 56 and the reactors) of the electric-power control unit 54, wherein the components are stored in the surplus space B1.

The electric-power control unit 54 is disposed in a space created by reduction of the vertical size of the transaxle 92, and a space is created vertically above the drive unit 90.

In the vehicle 10, the first electric motor MG1 and the second electric motor MG2 are cooled by the oil FLD. The oil FLD is used also for cooling the electric-power control unit 54. There will be specifically described a cooling system using the oil FLD by way of example in which the first electric motor MG1 is cooled.

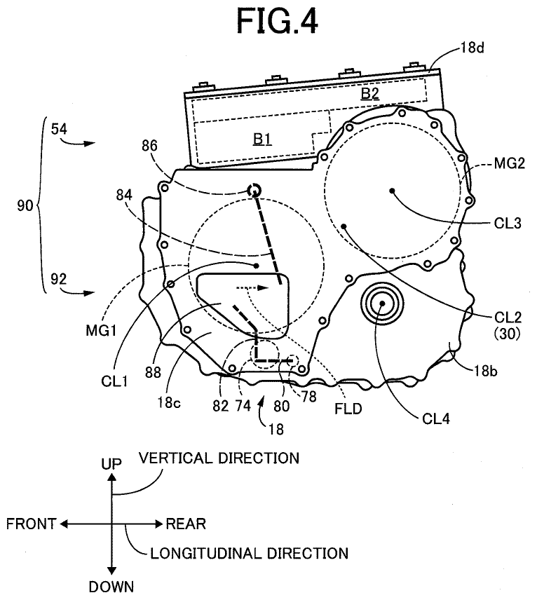

FIG. 4 is a view schematically showing, by way of example, the cooling system using the oil FLD. FIG. 5 is a view showing, by way of example, a structure of the cover 18c of the casing 18 in the cooling system using the oil FLD. FIG. 4 is a side view as viewed from a left side of the vehicle 10. FIG. 5 is a perspective view as viewed from a right rear side of the vehicle 10.

As shown in FIGS. 1, 4 and 5, the vehicle 10 further includes an electric oil pump 74, an oil storage portion 76, a strainer 78, an intake oil passage 80, a discharge oil passage 82, an intermediate oil passage 84 and a cooling pipe 86 that are disposed in the casing 18. The vehicle 10 further includes an oil cooler 88 that is attached to the casing 18, for example, outside the cover 18c.

The oil storage portion 76 is an oil reservoir provided in a bottom portion of the gear room Rg and in which the oil FLD is stored. The electric oil pump 74 is driven based on a command supplied from the electronic control device 70, so as to receive the oil FLD supplied from the oil storage portion 76 via the strainer 78 and the intake oil passage 80, and discharge the oil FLD to the discharge oil passage 82.

The oil cooler 88 is a heat exchanger or the like that cools the oil FLD by heat exchange. In the oil cooler 88, the oil FLD is cooled by using, for example, electric or mechanical cooling fans, or is cooled by using a refrigerant such as coolant.

The oil FLD discharged to the discharge oil passage 82 is supplied to the intermediate oil passage 84 via the oil cooler 88. The intermediate oil passage 84 is an oil passage which is located on a downstream side of the oil cooler 88, and which is located between the oil cooler 88 and the cooling pipe 86 so as to guide the oil FLD to the cooling pipe 86.

The cooling pipe 86 is a cooling oil passage for injecting the oil FLD discharged by the electric oil pump 74, to the first electric motor MG1 for cooling the first electric motor MG1. The cooling pipe 86 is an overlay pipe disposed adjacent to and above the first electric motor MG1 in the vertical direction of the vehicle 10. The cooling pipe 86 extends in the width direction of the vehicle 10, namely, in a direction parallel to the first axis CL1. In general, an electric motor is cooled by a so-called cooling from above and/or a so-called cooling from axial center. In the vehicle 10 according to the present embodiment, the first electric motor MG1 is cooled by at least the cooling from above.

In the drive unit 90 in which the electric-power control unit 54 is disposed above the transaxle 92 in the vertical direction of the vehicle 10, the electric-power control unit 54 is disposed adjacent to and above the first electric motor MG1 in the vertical direction. A physical distance between the first electric motor MG1 and the electric-power control unit 54 needs to be reduced for reducing a vertical size of the drive unit 90. However, the reduction of the physical distance between the first electric motor MG1 and the electric-power control unit 54 causes heat to be easily received between the first electric motor MG1 and the electric-power control unit 54.

Therefore, the cooling pipe 86 is disposed between the first electric motor MG1 and the electric-power control unit 54. For example, the cooling pipe 86 is disposed between the first electric motor MG1 and the lower-side portion (i.e., the components housed in the surplus space B1) of the electric-power control unit 54. The cooling pipe 86 is provided with a plurality of injection holes formed in its circumferential wall, for example, such that the injection holes open toward the first electric motor MG1 and the electric-power control unit 54, and such that the oil FLD is to be injected from the injection holes. With the oil FLD being injected from the injection holes of the cooling pipe 86 that are located above the first electric motor MG1, the oil FLD flows from above to down in the vertical direction of the vehicle 10 whereby an entirety of the first electric motor MG1 can be cooled. With the electric-power control unit 54 being disposed above the cooling pipe 86 in the vertical direction, the electric-power control unit 54 can be efficiently cooled even by a reduced number of the cooling pipe 86.

With the cooling pipe 86 being disposed between the first electric motor MG1 and the electric-power control unit 54, both of the first electric motor MG1 and the electric-power control unit 54 can be cooled by the oil FLD. Owing to this arrangement, it is possible to maximize efficiency of cooling by the oil FLD and also to minimize a space required to dispose the cooling pipe 86.

There is conduction of heat between the first electric motor MG1 and the electric-power control unit 54 via the bus bars 68. Where the physical distance between the first electric motor MG1 and the electric-power control unit 54 is reduced, the bus bars 68 are shortened whereby heat dissipation of the bus bars 68 is reduced. The reduction of the heat dissipation of the bus bars 68 causes heat to be easily received between the first electric motor MG1 and the electric-power control unit 54.

Therefore, the cooling pipe 86 is disposed between two of the plurality of bus bars 68u, 68v, 68w, so that it is possible to cool heat path between the first electric motor MG1 and the electric-power control unit 54 and to suppress heat from being received between the first electric motor MG1 and the electric-power control unit 54.

One of the bus bars 68 with a shorter path has a poor heat dissipation as compared to another of the bus bars 68 with a longer path. Thus, it is possible to efficiently suppress heat from being received between the first electric motor MG1 and the electric-power control unit 54, by injecting the oil FLD to one of the bus bars 68 with the shorter path. The above-described two of the plurality of bus bars 68u, 68v, 68w are two of the bus bars 68u, 68v, 68w which are shorter than another of the bus 20) bars 68u, 68v, 68w, namely, which have shorter paths than that of the another of the bus bars 68u, 68v, 68w, for example.

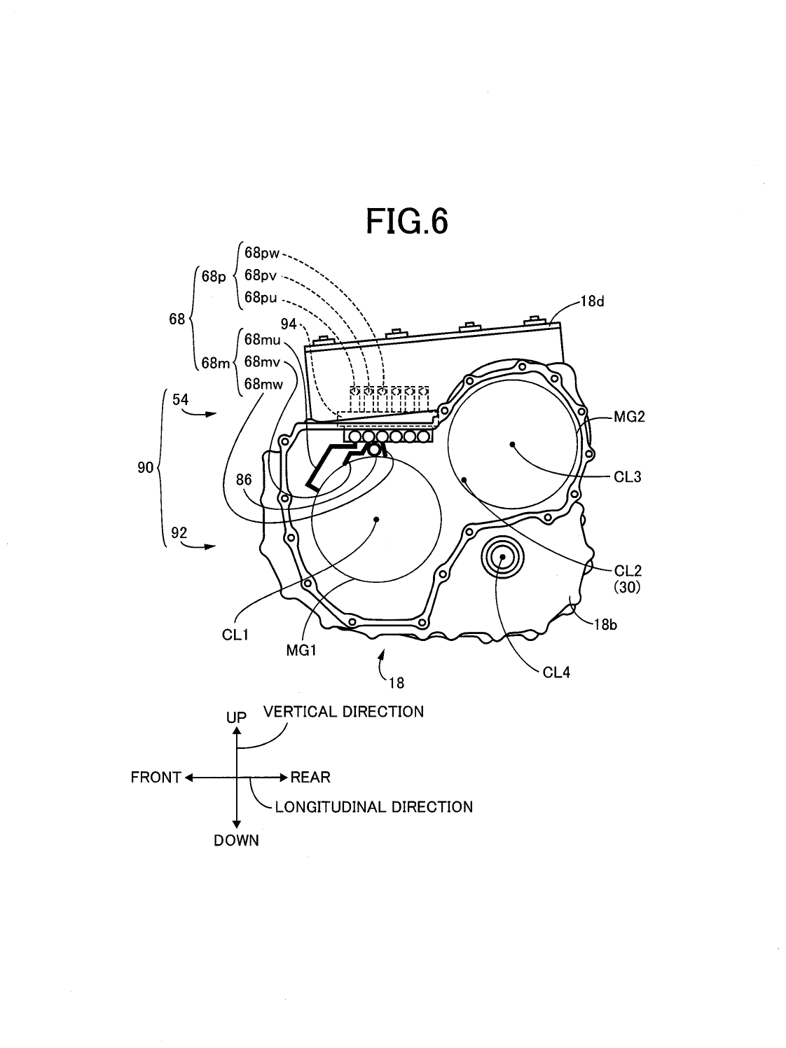

FIG. 6 is a view showing, by way of example, the cooling system in which the cooling pipe 86 is disposed between the bus bars 68. As shown in FIG. 6, the plurality of bus bars 68 include a plurality of MG bus bars 68m and a plurality of PCU bus bars 68p. The MG bus bars 68m are a plurality of electric-motor-side power line portions of the respective bus bars 68u, 68v, 68w, which are connected to the first electric motor MG1. The MG bus bars 68m include a plurality of MG bus bars 68mu, 68mv, 68mw. The PCU bus bars 68p are a plurality of electric-power-control-apparatus-side power line portions of the respective bus bars 68u, 68v, 68w, which are connected to the electric-power control unit 54. The PCU bus bars 68p include a plurality of PCU bus bars 68pu, 68pv, 68pw. The vehicle 10 further includes a terminal block 94 that connects between each of the plurality of MG bus bars 68mu, 68mv, 68mw and a corresponding one of the plurality of PCU bus bars 68pu, 68pv, 68pw. In the bus bar 68u, the MG bus bar 68mu and the PCU bus bar 68pu are connected through the terminal block 94. In the bus bar 68v, the MG bus bar 68mv and the PCU bus bar 68pv are connected through the terminal block 94. In the bus bar 68w, the MG bus bar 68mw and the PCU bus bar 68pw are connected through the terminal block 94. The cooling pipe 86 is disposed between two of the plurality of MG bus bars 68mu, 68mv, 68mw that are located between the first electric motor MG1 and the terminal block 94, wherein the two of the plurality of MG bus bars 68mu, 68mv, 68mw are included in the above-described two of the plurality of bus bars 68, and wherein the two of the plurality of MG bus bars 68mu, 68mv, 68mw are the MG bus bars 68mv, 68mw that are shorter than the MG bus bar 68mu in path.

As described above, in the present embodiment, the cooling pipe 86, which is configured to supply the oil FLD to the first electric motor MG1 for cooling the first electric motor MG1, is disposed between the first electric motor MG1 and the electric-power control unit 54 that is disposed adjacent to and above the first electric motor MG1 in the vertical direction of the electric vehicle. Owing to this arrangement, both of the first electric motor MG1 and the electric-power control unit 54 are cooled by the oil FLD injected from the cooling pipe 86, whereby heat generation in the first electric motor MG1 and the electric-power control unit 54 can be suppressed. It is therefore possible to improve performance for cooling the first electric motor MG1 and the electric-power control unit 54.

In the present embodiment, the cooling pipe 86 is disposed between two of the bus bars 68u, 68v, 68w. Owing to this arrangement, the bus bars 68 are cooled by the oil FLD injected from the cooling pipe 86, so that it is possible to suppress heat from being received between the first electric motor MG1 and the electric-power control unit 54.

In the present embodiment, the above-described two of the plurality of bus bars 68u, 68v, 68w are shorter than another of the plurality of bus bars 68u, 68v, 68w. Owing to this arrangement, the two bus bars 68 having shorter lengths and poorer heat dissipation than another bus bar 68 are cooled, so that it is possible to efficiently suppress heat from being received between the first electric motor MG1 and the electric-power control unit 54.

In the present embodiment, the cooling pipe 86 is disposed between two of the MG bus bars 68mu, 68mv, 68mw that are located between the first electric motor MG1 and the terminal block. Owing to this arrangement, the bus bars 68u, 68v, 68w are cooled by the oil FLD injected from the cooling pipe 86, so that it is possible to appropriately suppress heat from being received between the first electric motor MG1 and the electric-power control unit 54.

In the present embodiment, the cooling pipe 86 is located between the first electric motor MG1 and the lower-side portion of the electric-power control unit 54. Owing to this arrangement, the first electric motor MG1 and the lower-side portion of the electric-power control unit 54 are both cooled by the oil FLD injected from the cooling pipe 86 whereby heat generation can be suppressed in the electric motor MG1 and the electric-power control unit 54.

In the present embodiment, the cooling pipe 86 extends in parallel to the rotation axis of the first electric motor MG1, i.e., in the width direction of the vehicle 10. Owing to this arrangement, the cooling oil FLD can be caused to flow from above to down in the vertical direction of the vehicle 10, over an entirety of the first electric motor MG1 in the width direction of the vehicle 10, whereby the entirety of the first electric motor MG1 can be efficiently cooled.

While an embodiment of the present disclosure has been described in detail by reference to the drawings, it is to be understood that the present disclosure May be otherwise embodied.

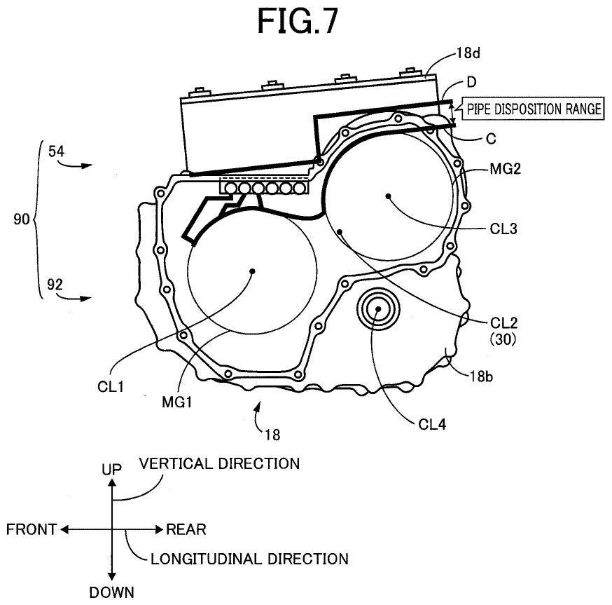

For example, in the above-described embodiment, the second electric motor MG2 as well as the first electric motor MG1 may be cooled by the cooling from above. That is, the present disclosure is applicable also to the second electric motor MG2. It is possible to obtain certain effects of the present disclosure as long as the cooling pipe is disposed between the electric motor (MG1, MG2) and the electric-power control unit 54. FIG. 7 is a view showing, by way of example, a range in which the cooling pipe is disposed. As shown in FIG. 7, the cooling pipe may be disposed in a range defined between a thick line C and a thick line D.

In the above-described embodiment, the transaxle 92 and the electric-power control unit 54 are disposed in respective spaces that are divided from each other by the partition wall inside the casing 18. However, the transaxle 92 and the electric-power control unit 54 may be disposed in the same space without such a partition wall.

In the above-described embodiment, the oil pump, which is configured to discharge the oil FLD, may be constituted by a mechanical oil pump in place of or in addition to the electric oil pump 74.

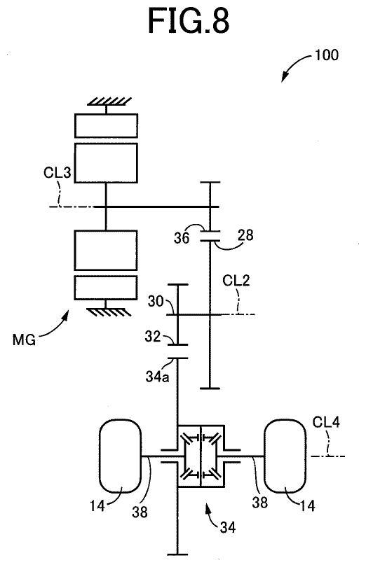

FIG. 8 is a view showing, by way of example, a construction of an electric vehicle 100 to which the present disclosure is applied, wherein the electric vehicle 100 is constructed according to a modification of the embodiment of the present disclosure. As shown in FIG. 8, the electric vehicle 100 is provided with an electric motor MG functioning as a power source. The electric vehicle 100 shown in FIG. 8 is different from the above-described electric vehicle 10 mainly in that various components (such as the engine 12 and the transmission portion 24 including the first electric motor MG1) that are provided around the first axis CL1 are absent. The electric motor MG of the electric vehicle 100 corresponds to the second electric motor MG2 of the above-described electric vehicle 10. In the electric vehicle 100, the first electric motor MG1 is absent and the second electric motor MG2 functions as the electric motor MG, for example, in various components constituting the transaxle 92 that are shown in FIG. 3.

In the above-described embodiment, the electric vehicle may be a series hybrid electric vehicle including an engine, a driving electric motor that functions as a power source and an electric motor which is connected to the engine in a power transmittable manner and which generates an electric power by the power of the engine. In such a series hybrid electric vehicle, a power transmission path between the engine and the drive wheels may be disconnected or connected by operation of a clutch. Alternatively, the electric vehicle may be a parallel hybrid electric vehicle including an engine, a power transmission device that transmits the power from the engine to the drive wheels and an electric motor that transmits the power to the drive wheels via the power transmission device.

In the above-described embodiment and modification, each of the first electric motor MG1, second electric motor MG2 and electric motor MG does not necessarily have to be constituted by the three-phase alternating-current synchronous electric motor, but may be constituted by another type of electric motor such as a single-phase synchronous electric motor and an induction electric motor. Each of the power lines connecting between the electric motor and the electric-power control apparatus may be any type of power line as long as it is configured to flow an electric current for driving the electric motor.

It is to be understood that the embodiment and modification described above are given for illustrative purpose only, and that the present disclosure may be embodied with various modifications and improvements which may occur to those skilled in the art.

### NOMENCLATURE OF ELEMENTS

10: electric vehicle
16: power transmission device
18: casing
50: high-voltage battery (driving battery)
54: electric-power control unit (electric-power control apparatus)
62: inverter
64: MG1 power module (three-phase bridge circuit)
66: MG2 power module (three-phase bridge circuit)
68 (68u, 68v, 68w): bus bars (power lines)
68m (68mu, 68mv, 68mw): MG bus bars (electric-motor-side power line portions)
68p (68pu, 68pv, 68pw): PCU bus bars (electric-power-control-apparatus-side power line portions)
74: electric oil pump (oil pump)
86: cooling pipe (cooling oil passage)
90: drive unit (mechanical-electrical integrated unit)
92: transaxle (drive apparatus)
94: terminal block
CL1: first axis (rotation axis of first electric motor)
CL2: second axis (rotation axis of power transmission device)
CL3: third axis (rotation axis of second electric motor)
CL4: fourth axis (rotation axis of power transmission device)
FLD: oil
MG1: first electric motor (electric motor, synchronous electric motor)
MG2: second electric motor (electric motor, synchronous electric motor)
100: electric vehicle
MG: electric motor

What is claimed is:

1. An electric vehicle comprising:
an electric motor;
a power transmission device to which the electric motor is connected in a power transmittable manner;
a driving battery;
an electric-power control apparatus configured to control an electric power transmitted and received between the battery and the electric motor;
a mechanical-electrical integrated unit constituted by the electric-power control apparatus and a drive apparatus that includes the electric motor and the power transmission device;
a casing that houses the mechanical-electrical integrated unit;
an oil pump configured to discharge an oil; and
a cooling oil passage configured to supply the oil to the electric motor for cooling the electric motor;
wherein the electric-power control apparatus is disposed adjacent to and above the electric motor in a vertical direction of the electric vehicle, and
wherein the cooling oil passage is disposed between the electric motor and the electric-power control apparatus.

2. The electric vehicle according to claim 1, further comprising:
a plurality of power lines that electrically connect between the electric motor and the electric-power control apparatus,
wherein the cooling oil passage is disposed between two of the power lines.

3. The electric vehicle according to claim 2,
wherein the two of the plurality of power lines are shorter than another of the plurality of power lines.

4. The electric vehicle according to claim 2,
wherein the electric-power control apparatus includes an inverter that has a three-phase bridge circuit of U phase, V phase and W phase,
wherein the electric motor is a three-phase alternating-current synchronous motor that is to be driven by the inverter, and
wherein the plurality of power lines are three power lines configured to transmit a three-phase alternating current of U phase, V phase and W phase.

5. The electric vehicle according to claim 4,
wherein the two of the plurality of power lines are shorter than another of the plurality of power lines.

6. The electric vehicle according to claim 2,
wherein the plurality of power lines include a plurality of electric-motor-side power line portions and a plurality of electric-power-control-apparatus-side power line portions, such that the electric-motor-side power line portions are connected to the electric motor while the electric-power-control-apparatus-side power line portions are connected to the electric-power control apparatus,
the electric vehicle further comprising:
a terminal block that connects between each of the electric-motor-side power line portions and a corresponding one of the electric-power-control-apparatus-side power line portions,
wherein the cooling oil passage is disposed between two of the electric-motor-side power line portions which are included in the two of the power lines.

7. The electric vehicle according to claim 1,
wherein the electric motor includes a first electric motor and a second electric motor,
wherein the drive apparatus is disposed in the electric vehicle, such that a rotation axis of the first electric motor, a rotation axis of the second electric motor and a rotation axis of the power transmission device are parallel to a horizontal direction that is perpendicular to a longitudinal direction of the electric vehicle, and such that the rotation axis of the second electric motor and the rotation axis of the first electric motor are arranged in this order of description from above to below in the vertical direction,
wherein the electric-power control apparatus includes a lower-side portion which is located in a position overlapping with an upper-side portion of the second electric motor as seen in the longitudinal direction and which is located above the first electric motor in the vertical direction, and
wherein the cooling oil passage is located between the first electric motor and the lower-side portion of the electric-power control apparatus.

8. The electric vehicle according to claim 1,
wherein the cooling oil passage extends in parallel to a rotation axis of the electric motor.
